(19) United States
(12) Patent Application Publication
(10) Pub. No.: US 2024/0359962 A1
(43) Pub. Date: Oct. 31, 2024

(54) AERIAL WORK PLATFORM

(71) Applicant: Oshkosh Corporation, Oshkosh, WI (US)

(72) Inventor: Zeno Poltronieri, Oshkosh, WI (US)

(21) Appl. No.: 18/424,462

(22) Filed: Jan. 26, 2024

Related U.S. Application Data
(63) Continuation of application No. 16/384,594, filed on Apr. 15, 2019, now abandoned.

(30) Foreign Application Priority Data
Apr. 16, 2018 (IT) 102018000004537

(51) Int. Cl. B66F 11/04; B66F 13/00

(52) U.S. Cl. CPC B66F 11/046; B66F 13/00

(57) ABSTRACT

An aerial work platform is provided with a people-holding cage suitable to be moved by a lifting unit provided with a telescopic arm, which has four section bars that are movable between respective extracted positions and respective retracted positions under the thrust of an actuator cylinder and of two rope operating systems fitted inside the telescopic arm, and is provided with at least one pipe fitted inside the telescopic arm to feed an operating fluid along the telescopic arm.

### CROSS-REFERENCE TO RELATED APPLICATIONS

This patent application is a continuation of U.S. application Ser. No. 16/384,594, filed on Apr. 15, 2019, which claims the benefit of and priority to Italian Patent Application No. 102018000004537, filed on Apr. 16, 2018, the entire disclosures of which are incorporated by reference herein.

### TECHNICAL FIELD

The present invention relates to an aerial work platform.

In particular, the present invention relates to an aerial work platform of the type comprising a people-holding cage; and a support and transport assembly for the cage.

### BACKGROUND ART

Generally, the support and transport assembly for the cage comprises a self-propelled vehicle; a rotating turret coupled to the self-propelled vehicle for rotating, with respect to the self-propelled vehicle, around a substantially vertical axis of rotation; a lifting unit interposed between the turret and the cage to move the cage between a lowered rest position and a plurality of raised operating positions; and a stabilizer device to stabilize the aerial work platform in use.

The lifting unit comprises a telescopic arm comprising, in turn, a first section bar; a second section bar fitted inside the first section bar to move between a retracted position and an extracted position; a third section bar fitted inside the second section bar to move between a retracted position and an extracted position; and a fourth section bar fitted inside the third section bar to move between a retracted position and an extracted position.

The telescopic arm further comprises an operating device to move the aforementioned second, third, and fourth section bars between the respective extracted positions and the respective retracted positions.

The operating device comprises an actuator cylinder fitted inside the telescopic arm and interposed between the first section bar and the second section bar to move the second section bar between its extracted and retracted positions; a first rope-operated system fitted inside the telescopic arm to move the third section bar between its extracted and retracted positions; and a second rope-operated system fitted inside the telescopic arm to move the fourth section bar between its extracted and retracted positions.

The first rope-operated system usually comprises a first pair of ropes, which are coupled to the first section bar and the third section bar, and are wound around at least one first pulley coupled in an axially fixed manner to a first end of the second section bar; and a second pair of ropes, which are coupled to the first section bar and the third section bar, and are wound around at least one second pulley coupled in an axially fixed manner to a second end of the second section bar opposite the first end of the second section bar.

The second rope-operated system usually comprises a first pair of ropes, which are coupled to the second section bar and the fourth section bar, and are wound around at least one first pulley coupled in an axially fixed manner to a first end of the third section bar; and a second pair of ropes, which are coupled to the second section bar and the fourth section bar, and are wound around at least one second pulley coupled in an axially fixed manner to a second end of the third section bar opposite the first end of the third section bar.

The lifting unit further comprises at least one pipe (usually a plurality of pipes) to feed an operating fluid along the telescopic arm.

Each pipe comprises a first flexible segment fitted inside a first cable-holding chain, which extends outside the telescopic arm and is fixed to the first section bar and the third section bar; and a second flexible segment fitted inside a second cable-holding chain, which extends outside the telescopic arm and is fixed to the third section bar and the fourth section bar.

Since, usually, the four section bars must have relatively small cross-sections to meet regulatory and/or functional restrictions, the known aerial work platforms of the type described above have some drawbacks mainly due to the fact that the flexible segments of the pipes and the respective cable-holding chains must be mounted outside the telescopic arm and are therefore exposed to the risk of impacts and damage.

### DISCLOSURE OF INVENTION

The object of the present invention is to provide an aerial work platform, which is free of the drawbacks described above and simple and economical to implement.

According to the present invention, an aerial work platform is provided as claimed in the appended claims.

### BRIEF DESCRIPTION OF THE DRAWINGS

The present invention will now be described with reference to the accompanying drawings, which illustrate a non-limiting embodiment thereof, in which:

FIG. 1 is a schematic side view, with parts removed for clarity, of a preferred embodiment of the aerial work platform of the present invention;

FIG. 2 is a perspective view of a detail of the aerial work platform in FIG. 1;

FIG. 3 is a schematic perspective view, with parts in section and parts removed for clarity, of a first detail of FIG. 2;

FIG. 4 is a schematic perspective view, with parts in section and parts removed for clarity, of a second detail of FIG. 2;

FIG. 5 is a schematic perspective view, with parts in section and parts removed for clarity, of a third detail of FIG. 2;

FIG. 6 is a schematic perspective view, with parts in section and parts removed for clarity, of a fourth detail of FIG. 2;

FIG. 7 is a schematic perspective view, with parts in section and parts removed for clarity, of a fifth detail of FIG. 2;

FIG. 8 is a schematic perspective view, with parts in section and parts removed for clarity, of a sixth detail of FIG. 2; and

FIG. 9 is a schematic perspective view, in enlarged scale, of a detail of FIG. 8.

### BEST MODE FOR CARRYING OUT THE INVENTION

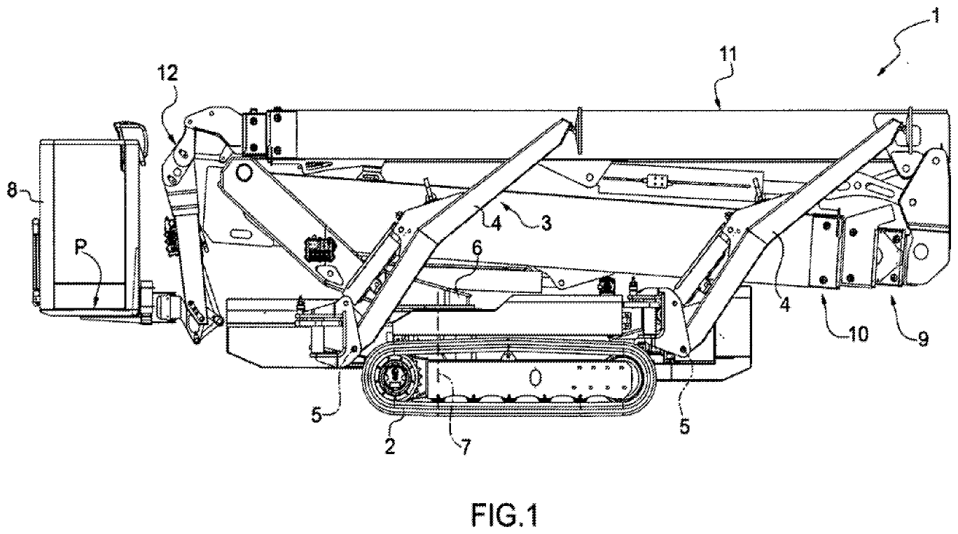

With reference to FIG. 1, reference numeral 1 indicates, as a whole, an aerial work platform comprising a tracked vehicle 2 provided with a stabilizer device 3 of a known type suitable to stabilize the aerial work platform 1 in use.

The device 3 comprises a plurality of oscillating arms 4 (in this case four arms 4), each of which is rotatably coupled to the vehicle 2 so as to oscillate, with respect to the vehicle 2, around a respective substantially horizontal fulcrum axis 5 between a rest position (FIG. 1) and an operating position (not shown).

The vehicle 2 further supports a rotating turret 6, which extends upwards from the vehicle 2 and is rotatably coupled to the vehicle 2 so as to rotate, with respect to the vehicle 2 and under the thrust of an operating device, of a known type and not shown, around a substantially vertical axis of rotation 7.

The aerial work platform 1 further comprises a people-holding cage 8 of a known type, which has a substantially horizontal supporting surface P and is connected to the turret 6 by the interposition of a lifting unit 9 configured to move the cage 8 between a lowered rest position (FIG. 1) and a plurality of raised operating positions (not shown).

The unit 9 comprises a plurality of lifting arms (in this case three lifting arms 10, 11, 12) arranged in succession and connected together in a known manner.

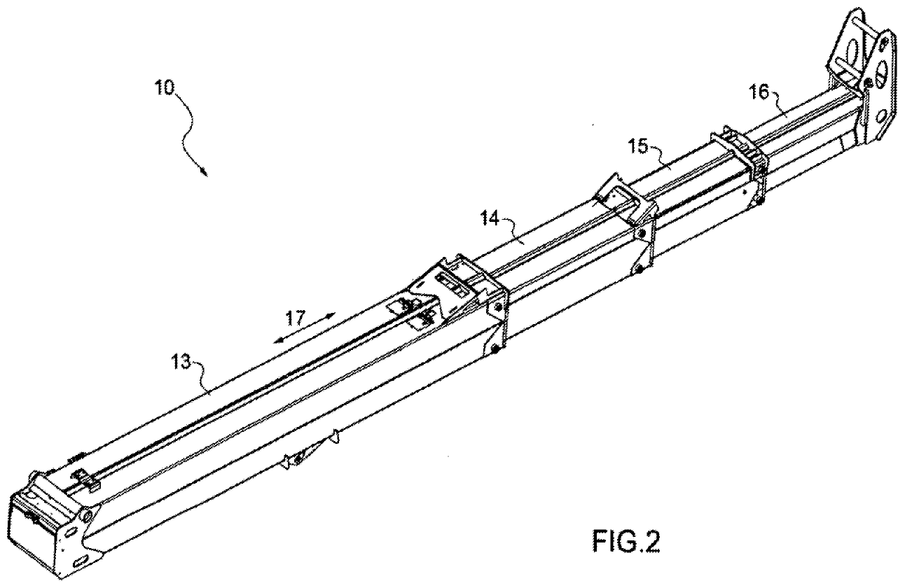

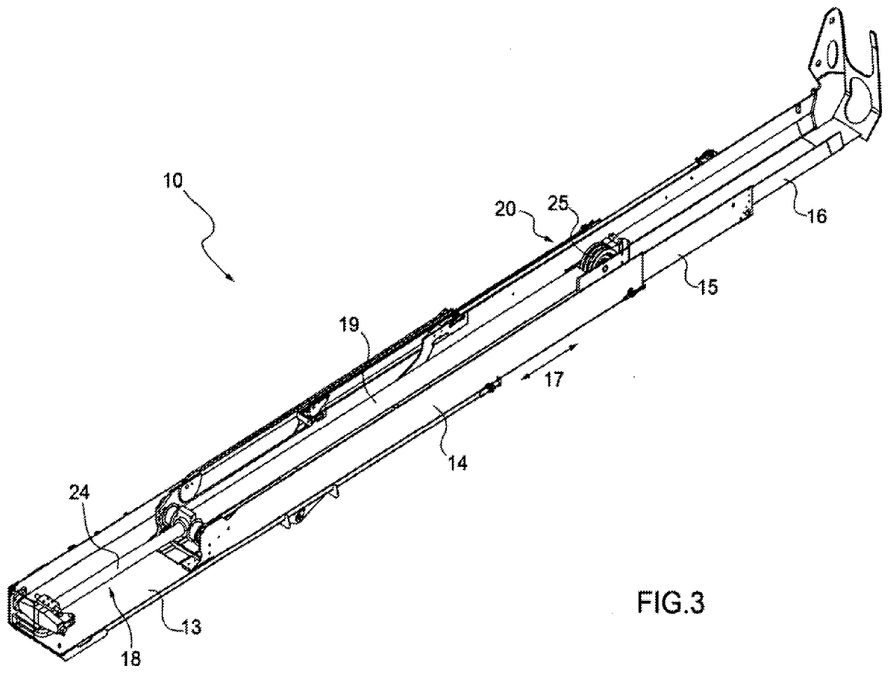

As shown in FIG. 2, the arm 10 is a telescopic arm comprising an axially fixed section bar 13 connected to the turret 6, and three movable section bars 14, 15, 16, of which the section bar 14 is fitted inside the section bar 13 and slidably coupled thereto, the section bar 15 is fitted inside the section bar 14 and slidably coupled thereto, and the section bar 16 is connected to the arm 11 and fitted inside the section bar 15 and slidably coupled thereto.

The section bars 14, 15, 16 have a parallelepiped shape with a substantially rectangular section and are movable between a retracted position (FIG. 1), in which the arm 10 has its minimum length, and an extracted position (not shown), in which the arm 10 has its maximum length.

With reference to Figures from 3 to 6, the section bars 14, 15, 16 are moved between the aforesaid retracted and extracted positions in a substantially rectilinear direction of movement 17 by an operating device 18 comprising an actuator cylinder 19, to move the section bar 14 between its retracted and extracted positions, a pair of rope-operated systems 20, 21, to move the section bar 15 between its extracted and retracted positions, and a pair of rope-operated systems 22, 23, to move the section bar 16 between its extracted and retracted positions.

The cylinder 19 extends inside the arm 10, is fixed to the section bar 14 parallel to direction 17, and has an output rod 24 fastened to the section bar 13.

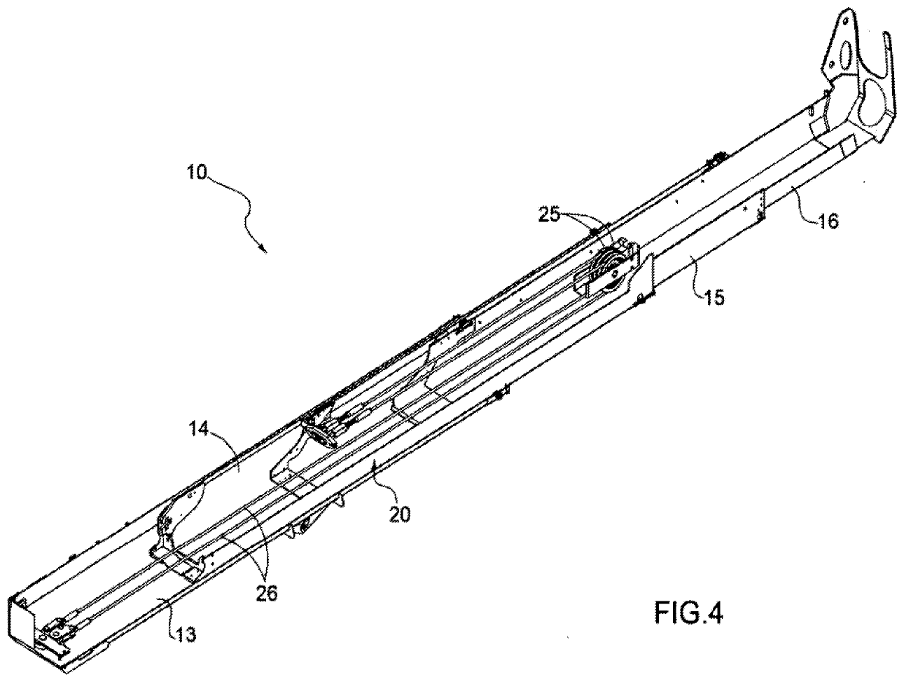

As shown in FIG. 4, the system 20 is fitted inside the arm 10, and in this case comprises a pair of pulleys 25 rotatably mounted at one free end of the cylinder 19, hence of the section bar 14, to move integrally with the section bar 14 in direction 17.

The system 20 further comprises a pair of ropes 26, each of which is wound around a respective pulley 25 and has two free ends, one fixed to the section bar 13 and the other one to the section bar 15.

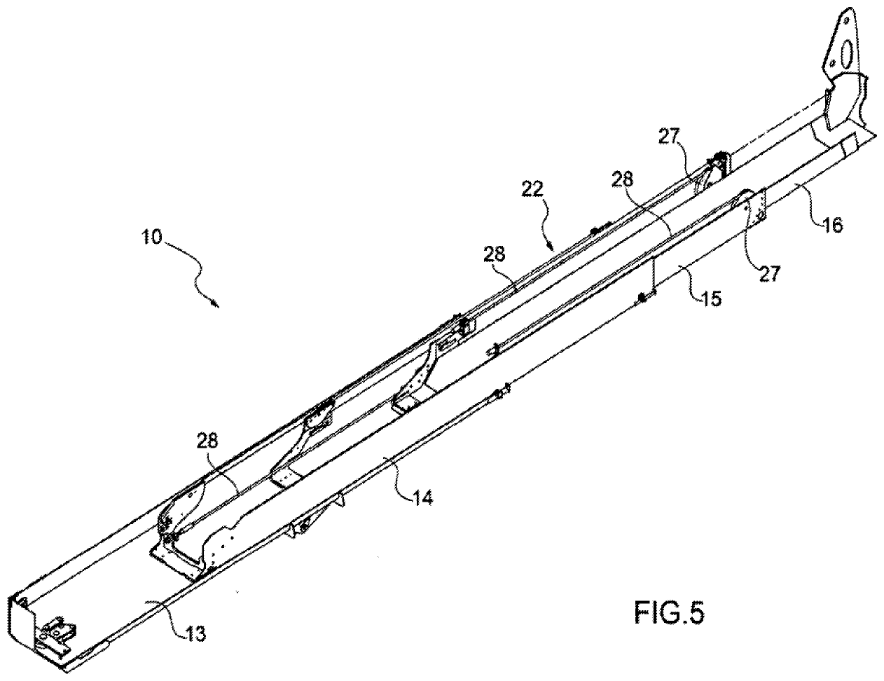

With reference to FIG. 5, the system 22 is fitted inside the arm 10, and in this case comprises a pair of pulleys 27 rotatably mounted at one free end of the section bar 15, to move integrally with the section bar 15 in direction 17.

The system 22 further comprises a pair of ropes 28, each of which is wound around a respective pulley 27 and has two free ends, one fixed to the section bar 14 and the other one to the section bar 16.

In use, the actuation of the cylinder 19 to move the section bar 14 from its retracted position to its extracted position involves both the movement of the pulleys 25 in direction 17, therefore the dragging of the section bar 15 by the ropes 26, and the movement of the pulleys 27 in direction 17, therefore the dragging of the section bar 16 by the ropes 28.

In other words, the actuation of the cylinder 19 to move the section bar 14 from its retracted position to its extracted position allows the two rope-operated systems 20, 22 to directly move the section bars 15 and 16 from their retracted positions to their extracted positions.

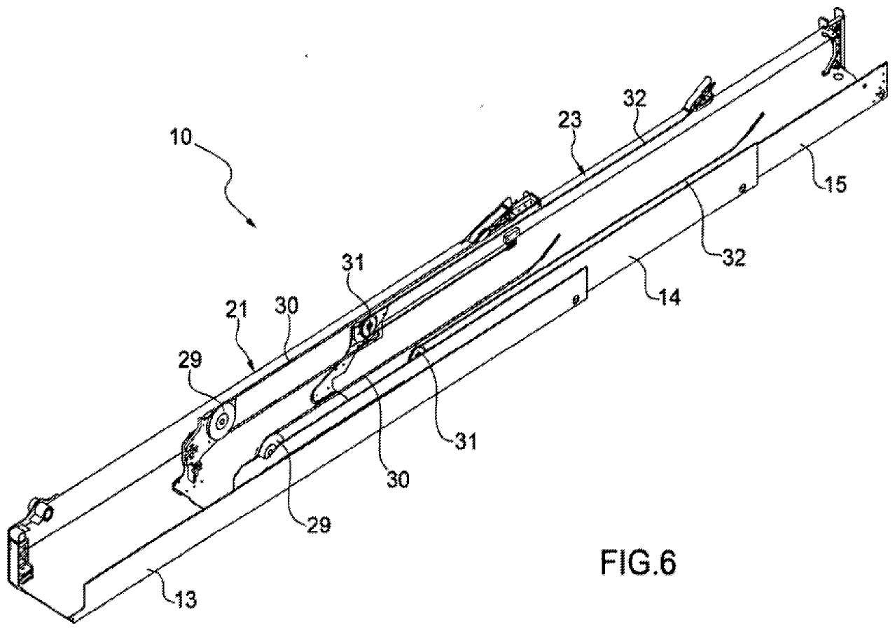

As shown in FIG. 6, the system 21 is fitted inside the arm 10, and in this case comprises a pair of pulleys 29, which are rotatably mounted at one free end of the section bar 14 opposite the free end of the section bar 14 on which the pulleys 25 are mounted, and are movable integrally with the section bar 14 in direction 17.

The system 21 further comprises a pair of ropes 30, each of which is wound around a respective pulley 29 and has two free ends, one fixed to the section bar 13 and the other one to the section bar 15.

The system 23 is fitted inside the arm 10, and in this case comprises a pair of pulleys 31, which are rotatably mounted at one free end of the section bar 15 opposite the free end of the section bar 15 on which the pulleys 27 are mounted, and are movable integrally with the section bar 15 in direction 17.

The system 23 further comprises a pair of ropes 32, each of which is wound around a respective pulley 31 and has two free ends, one fixed to the section bar 14 and the other one to the section bar 16.

In use, the actuation of the cylinder 19 to move the section bar 14 from its extracted position to its retracted position involves both the movement of the pulleys 29 in direction 17, therefore the dragging of the section bar 15 by the ropes 30, and the movement of the pulleys 31 in direction 17, therefore the dragging of the section bar 16 by the ropes 32.

In other words, the actuation of the cylinder 19 to move the section bar 14 from its extracted position to its retracted position allows the two rope-operated systems 21, 23 to directly move the section bars 15 and 16 from their extracted positions to their retracted positions.

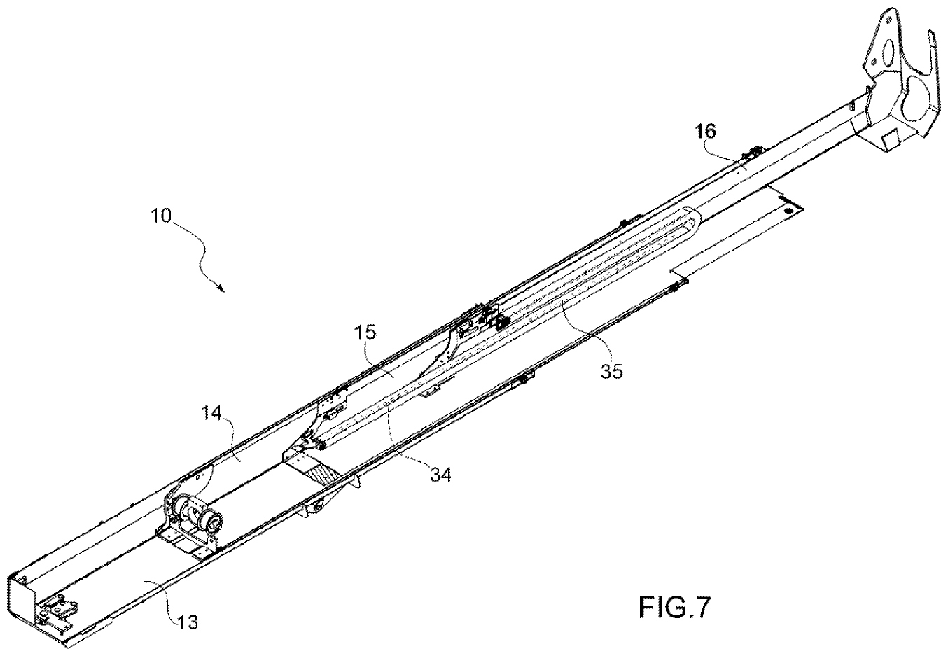

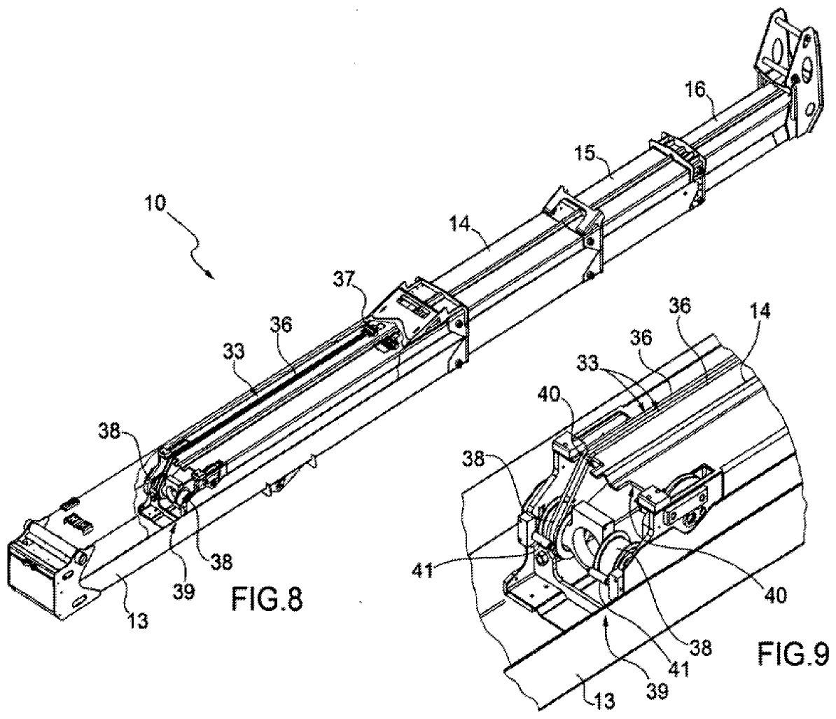

With reference to FIGS. 7, 8 and 9, the unit 9 further comprises a plurality of pipes 33 (in this case four pipes 33, only two of which are shown in FIGS. 8 and 9) fitted inside the arm 10 to feed an operating fluid, usually oil, along the arm 10 to at least one user (not shown) connected above the arm 10.

Each pipe 33 comprises a flexible segment 34 housed inside a cable-holding chain 35, which is fitted inside the arm 10 and fixed at its free ends to the section bar 15 and the section bar 16, to guide the flexible segment 34 during the movements of the section bar 16 between its extracted and retracted positions.

The flexible segment 34 is fastened to the section bars 15 and 16, configured to feed the operating fluid from the section bar 15 to the section bar 16, and connected to a further flexible or rigid segment (not shown) of the pipe 33 fixed along the section bar 16.

Each pipe 33 further comprises a flexible segment 36 (FIGS. 8 and 9), which has one first free end 37 fastened to the section bar 13, is wound around a respective pulley 38 rotatably mounted at one open free end of the section bar 14, extends inside the section bar 14, and has one second free end (not shown) fastened to the section bar 15.

The flexible segment 36 is configured to feed the operating fluid from the section bar 13 to the section bar 15, is connected to the flexible segment 34, and also connected to a further flexible or rigid segment (not shown) of the pipe 33 fixed along the section bar 13.

The flexible segment 36 is housed inside the arm 10, and extends parallel to direction 17 inside a hollow space defined between the section bar 13 and the section bar 14.

The pulleys 38 define part of a guide device 39 further comprising, in this case, two sliding guides 40 formed on the section bar 14 and slidably engaged by the flexible segments 36 of the pipes 33 and, for each pulley 38, a respective countering roller 41 mounted on the section bar 14.

Since the flexible segments 36 of the pipes 33 are guided within the hollow space defined between the section bar 13 and the section bar 14 and by the guide device 39, the aerial work platform 1 has some advantages mainly due to the fact that the flexible segments 36 of the pipes 33 do not have to be guided within a cable-holding chain similar to the cable-holding chain 35 and that, consequently, the assembly defined by the actuator cylinder 19, the rope-operated systems 20, 21, 22, 23, the pipes 33 and the cable-holding chain 35 can be entirely housed inside the arm 10.

1-11. (canceled)

12. A boom assembly for a lift device, the boom assembly comprising:
a first boom section;
a second boom section extending within the first boom section;
a third boom section extending within the second boom section;
a fourth boom section extending within the third boom section, wherein an internal volume of the boom assembly is defined within the first boom section, the second boom section, the third boom section, and the fourth boom section;
an actuator coupled to the first boom section and the second boom section and configured to extend the second boom section relative to the first boom section;
a first extension system including a first tensile member and a first pulley engaging the first tensile member, the first extension system being configured to extend the third boom section relative to the second boom section; and
a second extension system including a second tensile member and a second pulley engaging the second tensile member, the second extension system being configured to extend the fourth boom section relative to the third boom section,
wherein the first extension system and the second extension system are contained entirely within the internal volume of the boom assembly.

13. The boom assembly of claim 12, wherein the first tensile member has a first end portion coupled to the first boom section and a second end portion coupled to the third boom section, and wherein the first pulley is coupled to the second boom section.

14. The boom assembly of claim 13, wherein the actuator includes a rod fixedly coupled to the first boom section and a body fixedly coupled to the second boom section, the body receiving the rod, and wherein the first pulley is indirectly coupled to the second boom section by the body of the actuator.

15. The boom assembly of claim 13, wherein the first tensile member of the first extension system extends within the fourth boom section.

16. The boom assembly of claim 13, wherein the second tensile member has a first end portion coupled to the second boom section and a second end portion coupled to the fourth boom section, and wherein the second pulley is coupled to the third boom section.

17. The boom assembly of claim 16, wherein the second tensile member of the second extension system extends outside of the fourth boom section and within the third boom section.

18. The boom assembly of claim 17, wherein the third boom section includes a first side wall extending substantially vertically, wherein the fourth boom section includes a second side wall offset from the first side wall, and wherein the second tensile member of the second extension system extends between the first side wall and the second side wall.

19. The boom assembly of claim 12, wherein the actuator includes a rod fixedly coupled to the first boom section and a body fixedly coupled to the second boom section, the body receiving the rod, and wherein the first boom section, the second boom section, the third boom section, and the fourth boom section are repositionable from a fully retracted position to a fully extended position while the rod is fixedly coupled to the first boom section.

20. The boom assembly of claim 12, wherein the first tensile member is a rope.

21. The boom assembly of claim 12, wherein the actuator is contained entirely within the internal volume of the boom assembly.

22. The boom assembly of claim 12, further comprising:
a first retraction system including a third tensile member and a third pulley engaging the third tensile member, the first retraction system being configured to retract the third boom section relative to the second boom section; and
a second retraction system including a fourth tensile member and a fourth pulley engaging the fourth tensile member, the second retraction system being configured to retract the fourth boom section relative to the third boom section.

23. The boom assembly of claim 12, further comprising a pipe configured to transfer a fluid, the pipe having a first portion coupled to the first boom section and a second portion coupled to the fourth boom section, wherein a first segment of the pipe extends between a first wall of the first boom section and a second wall of the second boom section.

24. The boom assembly of claim 23, further comprising a third pulley coupled to the second boom section, wherein a second segment of the pipe is wound around the third pulley, and wherein a third segment of the pipe extends within the second boom section.

25. The boom assembly of claim 24, further comprising a flexible chain receiving a fourth segment of the pipe and extending within the fourth boom section, wherein a first end portion of the flexible chain is coupled to the third boom section, and wherein a second end portion of the flexible chain is coupled to the fourth boom section.

26. A boom assembly for a lift device, the boom assembly comprising:
a first boom section including a first wall;
a second boom section extending within the first boom section and including a second wall;
a third boom section extending within the second boom section;
a fourth boom section extending within the third boom section;
at least one actuator configured to move the first boom section, the second boom section, the third boom section, and the fourth boom section between a fully retracted position and a fully extended position; and
a pipe configured to transfer a fluid, the pipe having a first portion coupled to the first boom section and a second portion coupled to the fourth boom section,
wherein a first segment of the pipe extends between the first wall of the first boom section and the second wall of the second boom section.

27. The boom assembly of claim 26, further comprising a pulley coupled to the second boom section, wherein a second segment of the pipe is wound around the pulley, and wherein a third segment of the pipe extends within the second boom section.

28. The boom assembly of claim 27, further comprising a flexible chain receiving a fourth segment of the pipe, wherein a first end portion of the flexible chain is coupled to the third boom section, and wherein a second end portion of the flexible chain is coupled to the fourth boom section.

29. The boom assembly of claim 28, wherein the flexible chain extends within the fourth boom section.

30. A boom assembly for a lift device, the boom assembly comprising:
a first boom section;
a second boom section extending within the first boom section;
a third boom section extending within the second boom section;
a fourth boom section extending within the third boom section;
at least one actuator configured to move the first boom section, the second boom section, the third boom section, and the fourth boom section between a fully retracted position and a fully extended position;
a pipe configured to transfer a fluid, the pipe having a first portion coupled to the first boom section and a second portion coupled to the fourth boom section; and
a flexible chain receiving a segment of the pipe, wherein a first end portion of the flexible chain is coupled to the third boom section, and wherein a second end portion of the flexible chain is coupled to the fourth boom section.

31. The boom assembly of claim 30, wherein the flexible chain extends within the fourth boom section.
